(19) United States
(12) Patent Application Publication
(10) Pub. No.: US 2026/0141401 A1
(43) Pub. Date: May 21, 2026

(54) Automated Workflow Management and Solution Recommendation in Customer Support Ticketing System

(71) Applicant: Zscaler, Inc., San Jose, CA (US)

(72) Inventors: Prasannakumar Jobigenahally Malleshaiah, San Jose, CA (US); Anirudh Achanta, San Jose, CA (US); Ashok Kolachina, Milpitas, CA (US); Manpreet Chadha, London (GB); Satish Kalipatnapu, Alpharetta, GA (US); Sanjay Kalra, San Jose, CA (US); Jay Makwana, Burnaby (CA); Shreyas Madapura Chandraiah, San Jose, CA (US); Saroj Panigrahy, Fremont, CA (US); Jaspreet Singh, Sunnyvale, CA (US)

(73) Assignee: Zscaler, Inc., San Jose, CA (US)

(21) Appl. No.: 18/953,336

(22) Filed: Nov. 20, 2024

(51) Int. Cl. G06Q 30/016; G06F 40/279

(52) U.S. Cl. CPC G06Q 30/015; G06F 40/279

(57) ABSTRACT

Systems and methods for handling customer support tickets are provided. A method, according to one implementation, includes a step of dynamically summarizing ticket content of a new ticket to obtain partial summaries and a final summary of the new ticket, wherein the new ticket is opened in order to resolve an incident in a domain. The method also includes a step of transforming the final summary into a numerical vector. Also, the method includes performing a similarity search to compare the numerical vector with pre-stored vectors in a vector database, wherein the pre-stored vectors are associated with previously resolved incidents in the domain. The method may further include triggering predefined actions based on the similarity search.

### TECHNICAL FIELD

The present disclosure generally relates to cloud-based customer support systems. More particularly, the present disclosure relates to automated ticketing systems configured to leverage Large Language Models (LLMs) and embedding techniques to enhance customer support workflows.

### BACKGROUND

Generally, customer support teams manage a high volume of customer service tickets daily. For example, in a cybersecurity environment, trust entities may handle tickets involving recurring issues related to network congestion, downtime, authentication challenges, policy misconfigurations, among others. Addressing these issues currently requires multiple customer interactions, manual searches through past tickets, and heavy reliance on the experience of individual support agents. This manual approach increases the time required to resolve issues and limits the consistency and efficiency of customer support services.

### BRIEF SUMMARY

The present disclosure is directed to ticketing systems and processing customer service tickets. According to one implementation, a method includes a step of dynamically summarizing ticket content of a new ticket to obtain partial summaries and a final summary of the new ticket. For instance, the new ticket is opened in order to resolve an incident in a domain. The method further includes a step of transforming the final summary into a numerical vector. Also, the method includes a step of performing a similarity search to compare the numerical vector with pre-stored vectors in a vector database. The pre-stored vectors, for example, are associated with previously resolved incidents in the domain. The method also includes a step of triggering predefined actions based on the similarity search.

According to some embodiments, the method may further include a step of employing a Large Language Model (LLM) trained with previous cloud security tickets and cloud security knowledge. The new ticket, for example, may be related to cybersecurity alerts, issues, and monitored network data within a cloud-based cybersecurity environment. The method may further include steps of a) retrieving ticket descriptions, comments, and updates, and b) cleaning and normalizing ticket data and removing sensitive information for privacy compliance.

In some embodiments, the method may also include utilizing a RAG module to assist with retrieving similar tickets from the vector database. The ticket content, in some embodiments, may include user queries, user questions, initial input, requests, issues, alerts, concerns, new ticket information, descriptions, and/or comments regarding one or more issued detected within a domain. The predefined actions, in some embodiments, may include one or more resolution procedures for resolving or attempting to resolve an incident detected within a domain.

In addition, the method may also include requesting additional data with respect to the domain for updating the partial summaries. The step of triggering predefined actions may include a step of recommending solutions based on the previously resolved incidents. The new ticket, for example, may be related to customer service, customer support, Information Technology (IT) support, Human Resource (HR) support, project management, workflow management, task management, workflow coordination, application assistance, software development, software bug and issue tracking, solution recommendation, and/or issue resolution.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a block diagram illustrating a ticketing system for processing customer service tickets using Large Language Models (LLMs), according to various embodiments.

FIG. 2 is a block diagram illustrating another ticketing system using an LLM, according to various embodiments.

FIG. 3 is a block diagram illustrating a computing system of a ticketing platform, according to various embodiments.

FIG. 4 is a screenshot showing an example of partial summaries of a customer service ticket, according to various embodiments.

FIG. 5 is a screenshot showing a final summary of the example of FIG. 4, according to various embodiments.

FIG. 6 is a screenshot showing an entry field and summary in a chatbot application platform, according to various embodiments.

FIG. 7 is a flow diagram illustrating a method for utilizing LLMs for processing a customer service ticket, according to various embodiments.

### DETAILED DESCRIPTION

The present disclosure relates to systems and methods associated with customer service or customer support platforms, particularly ticketing systems, for managing tickets regarding issues within a network. As described herein, a “ticket” (e.g., customer service ticket, customer support ticket, and the like) refers to a record of a customer's interaction with a service representative and may be a key part of a business's customer support framework. In the present disclosure, the ticketing systems may be partially or fully automated, thereby reducing or eliminating the responsibilities of the service representative and replacing the human factor in this regard with chatbot systems, Large Language Models (LLMs), Artificial Intelligence (AI) models, Machine Learning (ML) models, etc. For example, cybersecurity entities (e.g., a cloud service provider) may handle multiple tickets every day for resolving security issues and other customer issues that arise during network operation. The embodiments described herein are configured to leverage LLMs to dynamically summarize ticket information.

A customer service ticket may be a formal request from a customer for help with a specific problem, a question regarding network operations (e.g., security applications within a domain), chat queries, problem reporting, etc. With automated assistance, solutions to customer problems may include answers that satisfy the customer's concerns, automated resolutions, network reconfigurations, debugging, measuring, and testing network equipment, and the like. Customer service tickets may be managed by the systems and methods of the present disclosure through a helpdesk-type ticketing system, which can help organizations (e.g., cybersecurity companies) track, monitor, prioritize, and categorize various tickets they receive from their customers. With the assistance of LLMs, the organizations can provide better and faster resolution of customer issues, thereby providing a better customer experience.

### Ticketing Systems

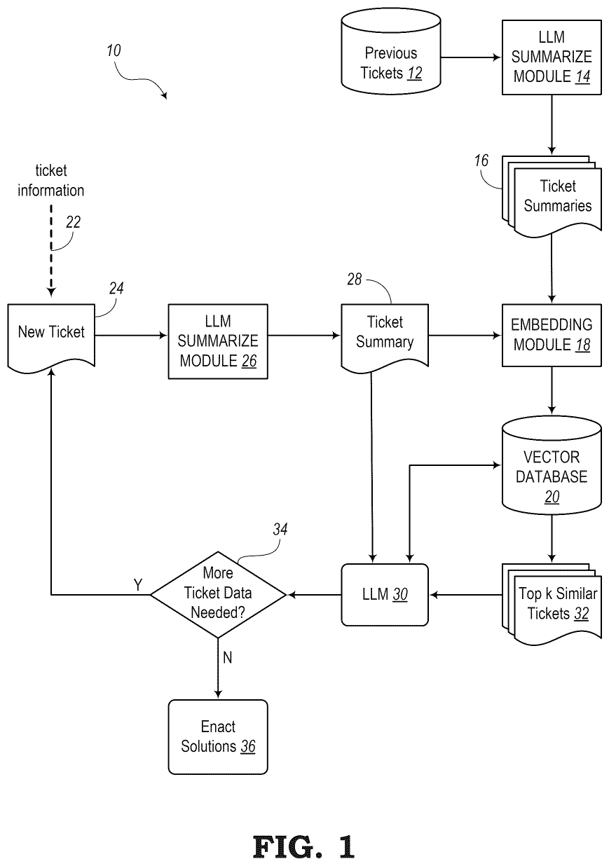

FIG. 1 is a block diagram illustrating an embodiment of a ticketing system 10 for processing customer service tickets using LLMs. As shown in FIG. 1, the ticketing system 10 includes a database 12 that stores previous tickets. For example, the previous tickets may include at least a number of tickets associated with a network domain for which issues (e.g., network issues) have already been resolved. Furthermore, the ticketing system 10 includes an LLM summarize module 14 that is configured to create “summaries” for the previous tickets resulting in ticket summaries 16. For example, summaries may include a short description of the overall issue, a time range during which the issue has occurred, monitoring and testing data of a network domain, a list of organizations, customers, and/or domain devices affected by the issue, information regarding attempts to resolve the issue, root cause analysis, and/or other data associated with the analysis of the issue and resolutions to the issue.

The ticket summaries 16 are applied to an embedding module 18 configured to convert the multi-dimensional features of each ticket summary to a multi-dimensional vector. The vectors are stored in a vector database 20, which is configured to store the multiple vectors associated with previous tickets as wells as continuously add new vectors associated with new tickets to establish a rich base of multiple types of issues that may arise within a domain and how these issues may be resolved.

The ticketing system 10 further includes an entry 22 of new ticket information, which may be obtained via a User Interface (UI) of a user or customer operating on behalf of a specific domain in which an issue is detected. The entry 22 may include information associated with the customer, organization, or domain and information regarding one or more issues, questions, queries, etc. regarding the domain. In some embodiments, new tickets may be opened automatically by domain systems that continuously monitor the customer's domain. In other embodiments, new tickets may be opened using a manual approach.

The new ticket information is used to create a new ticket 24. The ticketing system 10 also includes another LLM summarize module 26, which may be the same as or similar to the LLM summarize module 14. In this case, the LLM summarize module 26 is configured to summarize the information of the new ticket 24 to create a ticket summary 28. In addition, the ticketing system 10 includes an LLM 30 configured to receive data of the ticket summary 28 and process the ticket summary 28. One task of the LLM 30 involves the performance of a similarity search with respect to entries in the vector database 20, which may include providing the data from the ticket summary 28 to the vector database 20 and requesting the top k similar tickets 32 from the vector database 20. From the top k similar tickets 32, the LLM 30 can determine how to handle the current issue, as defined in the ticket summary 28. That is, the same or similar resolution steps taken in one or more previous tickets may also be followed with respect to the new ticket 24.

In some cases, the LLM 30 may determine that more ticket data is needed, as indicated in decision block 34. If so, the ticketing system 10 is configured to return back to an interface associated with the new ticket 24 to request additional information from the original requestor and/or obtain additional parameters from monitoring and telemetry systems associated with the customer domain of concern. In other cases, the LLM 30 may determine that a clear strategy for handling the new ticket 24 can be discovered from similar ticket resolution actions. As such, the LLM 30 may instruct applicable controllers to enact suitable solutions 36 to the domain of concern. For example, some solutions may include automatically modifying network configurations of the customer domain, rerouting or redirecting network traffic, optimizing routes, avoiding faulty nodes, restarting hardware devices and/or software applications, adding networking or processing capabilities, restoring connectivity, etc.

It may be noted that multiple LLMs can be used by the ticketing system 10. In some embodiments, multiple LLMs may be configured to operate in a cooperative manner. In other embodiments, the LLMs may operate independently of each other and/or may interact with each other according to a collaborative plan based on domain-specific policies and functionality.

The ticketing system 10 may be an automated customer support system that integrates domain-specific LLMs and embedding models tailored to a cloud security platform. One general feature of the ticketing system 10 includes “dynamic ticket summarization,” which may include automatically creating a concise summary of each support ticket upon creation. Dynamic ticket summarization may further include real-time updates for continuously updating the new ticket 24 and ticket summary 28 as new information is added. In this way, the new ticket 24 and ticket summary 28 may include comprehensive content, including summaries of domain details (e.g., issue descriptions, actions taken, findings, proposed next steps, etc.).

A second general feature of the ticketing system 10 may include “solution recommendation,” which can be based on historical data. This may include semantic analysis that uses embedding models to process ticket content semantically. Also, solution recommendation may include a similarity search that compares current tickets to historical data stored in the vector database 20. The recommendations, for instance, may suggest solutions that have been effective in resolving similar issues and/or may enact automated resolutions within the domain.

A third general feature of the ticketing system 10 may include “automated action triggering” (as indicated in block 36). The action triggering may be based on comment analysis of the information of the new ticket 24. This may include real-time monitoring to continuously monitor ticket comments for specific keywords, patterns, sentiments, etc. Predefined actions may be automatically triggered, such as requesting diagnostics, suggesting tools, and/or escalating tickets. Also, the ticketing system 10 can provide proactive support to enable timely and appropriate responses without manual intervention, increasing efficiency and customer satisfaction.

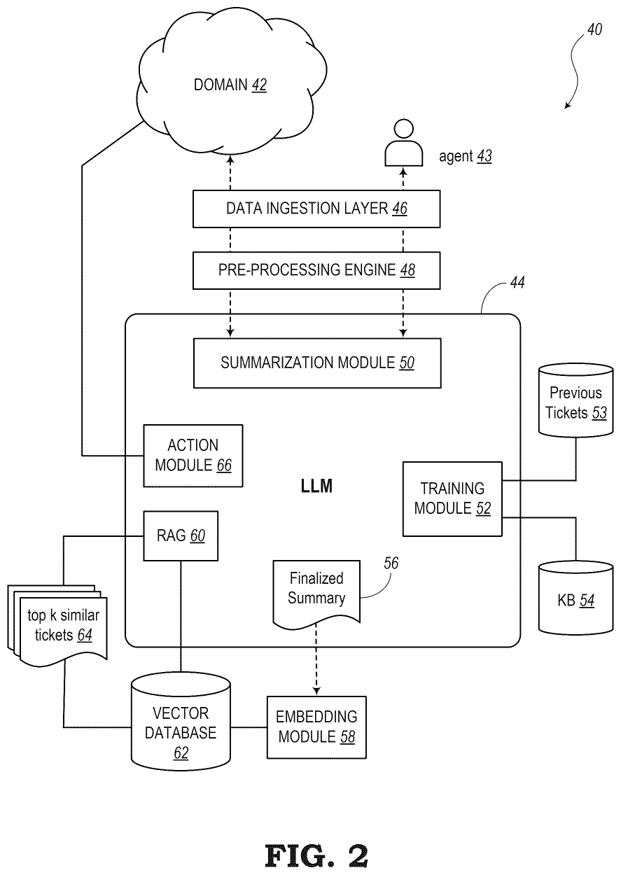

FIG. 2 is a block diagram illustrating another embodiment of a ticketing system 40 using an LLM. As shown in this embodiment, the ticketing system 40 includes a domain 42 or environment that is under observation. The domain 42 may refer to a network or organizational domain associated with a particular enterprise for which a user (e.g., network operator, technician, engineer, admin, etc.) may request the opening of a new ticket. Thus, the domain 42 may include network equipment, switches, routers, end user devices, network monitoring and telemetry systems, control systems, etc. In addition, an agent 43 associated with a cloud-based security entity may further provide manual clarifications, interpretations, input, etc. in addition to the manual or automated data and network metrics provided in the form of ticket information for requesting and defining a new ticket. The input regarding the opening of a new ticket is communicated to an LLM 44 or other cloud-based service system for handling customer service tickets.

The ticketing system 40 includes a data ingestion layer 46 and a pre-processing engine 48, which, in some embodiments, may be part of the LLM 44 or cloud-based ticket processing system. The data ingestion layer 46 may include Natural Language Processing (NLP) systems and devices, chatbot Uls, and other various systems for ingesting new ticket information. The pre-processing engine 48 may include NLP devices, AI models, ML models, etc. for cleaning the ticket information and putting the information into a usable format for suitable processing by the LLM 44. The data ingesting layer 46 and/or pre-processing engine 48 may be configured to pick up specific keywords, patterns, objectives, bullet points, etc.

As shown in FIG. 2, the LLM 44 may include a summarization module 50 configured to receive the ticket information and create a ticket summary of the new ticket opened for one or more specific issues within the domain 42. The LLM 44 may also include a training module 52, which may use AI or ML supervised training techniques. For example, the training module 52 may be configured to obtain data regarding previous tickets stored in a database 53 (e.g., ticket data related to resolved tickets for the domain 42) and may further obtain domain-specific details of the domain 42 as stored in a knowledge base 54. The domain-specific details may include topology information of the domain 42 and policies, standards, and protocols associated with the domain 42. The training module 52 may be configured to train the LLM 44 to enable the LLM 44 to effectively manage new tickets for the domain 42. It should be noted that the LLM 44 may be configured to be trained with respect to any number of domains to allow the processing of tickets for multiple customers or clients.

The LLM 44 may be configured to analyze the new domain-specific ticket information and create an ongoing summary that can be modified dynamically, as described with respect to FIG. 1. The LLM 4 may then produce a finalized summary 56 of the new ticket. The finalized summary 56 can be provided to an embedding module 58. Also, the LLM 44 may include a Retrieval-Augmented Generation (RAG) module 60, which may be configured to access a vector database 62 and retrieve top k similar tickets 64. Also, the embedding module 58 is configured to store vector data of multiple tickets in the vector database 62. The LLM 44 may further include an action module 66 configured to provide control signals to the domain 42 to change configuration tables, reroute transmission paths, or perform other changes to the domain 42 to reduce congestion or traffic, optimize routes, etc. As described with respect to FIG. 1, additional ticket information may be obtained from the domain 42 to modify the finalized summary 56 or an ongoing summary of the ticket.

The data ingestion layer 46 may be configured as an interface for integrating domain-specific data with the LLM 44. The data ingestion layer 46 is configured to be an interface with the LLM 44 of the ticketing system 40 using Application Programming Interfaces (APIs) to retrieve ticket data, including descriptions, comments, and updates. The pre-processing engine 48 may be configured for data cleaning to process and cleanse text data and may include secure privacy compliance in which the pre-processing engine 48 strips sensitive information to maintain compliance with data privacy regulations.

The LLM 44 may be configured as a domain-specific model for one or more domains to provide customized response based on the domain under observation. The training module 52 of the LLM 44 may be configured for customized training, where the LLM 44 can fine-tune the analysis of ticket information based on historical ticket data and domain-specific knowledge. The LLM 44 may also include cloud security proficiency and may specialize in understanding domain-specific terminology. For example, in the realm of cloud-based cybersecurity (e.g., using cloud tools), the LLM 44 may be configured to understand cloud security terminology, recognize common issues with respect to cloud security, and contextualize support requests.

The training and embedding models (e.g., embedding module 18, 58, training module 52, etc.), the ticketing systems 10, 40 may be configured with vector databases 20, 62, etc. for perform nearest neighbor and/or similarity searching to find previously discovered, tried and true solutions to current issues or tickets. The embedding modules 18, 58 may be configured for vector conversion to convert ticket content into numerical vector representations. Then, efficient searches may be conducted with respect to stored vectors in the searchable vector databases 20, 62 for efficient similarity-based solution recommendations. The LLMs may further analyze and process the recommendations as needed to fine-tune the analysis and resolution processes.

The action module 66 may be configured as an action triggering module, which may include pattern recognition using NLP techniques to analyze ticket comments for specific phrases or patterns. Automated actions may include detecting keywords and triggering predefined actions based on the content analysis.

The data ingestion layer 46 may be configured to connect to a ticketing system of a cloud security service (e.g., offered by a cloud service provider) via APIs. Also, the data ingestion layer 46 may be configured to retrieve ticket data, including descriptions, comments, and updates. The pre-processing engine 48 may be configured to clean and normalize text data and also remove sensitive information to comply with data privacy regulations.

The LLM 44 may be a domain-specific LLM configured to a) be fine-tuned on the domain's historical ticket data, and b) understand cloud security terminology and common issues. The embedding model (e.g., embedding module 58) and vector database 62 may be configured to a) convert ticket content into numerical vectors, and b) store vectors in a database for efficient similarity searches. The action module 66 or Action Triggering Module may be configured to a) analyze ticket comments using natural language processing, and b) detect patterns and trigger predefined actions.

An operational workflow, for example, may include:
1. Dynamic Ticket Summarization—generating an initial summary at the time of ticket creation, updating the summary as additional information becomes available, and allowing support agents (e.g., agent 43) to view a concise, current summary of the ticket at any time
2. Solution Recommendation—processing ticket content into embeddings for semantic representation, conducting similarity searches within the vector database to find relevant past tickets, and recommending solutions that have been successful in resolving similar issues.
3. Automated Action Triggering—monitoring ticket comments for specific triggers, such as diagnostic requests or escalations, and automated follow-up actions based on detected keywords or phrases.

### Computing System

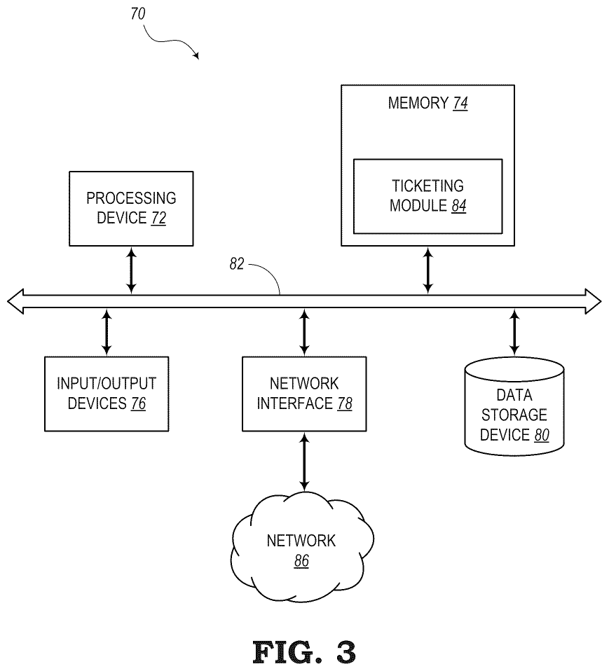

FIG. 3 is a block diagram illustrating an embodiment of a computing system 70 of a ticketing platform. As shown in its simplified form, the computing system 70 includes a processing device 72, memory 74, Input/Output (I/O) devices 76, a network interface 78, and a data storage device 80 (or database), interconnected with each other via a local interface 82 (or bus).

The processing device 72 may include one or more processors or microprocessors, such as a Central Processing Unit (CPU), which is configured to execute instructions and process data. The processing device 72 may be a general-purpose processor, a special-purpose processor, an Application-Specific Integrated Circuit (ASIC), or any combination thereof. The processing device 72 is configured to perform various computational tasks and manage the operations of the computing system 70, including executing software instructions stored in the memory 74. In some embodiments, the processing device 72 may also include or be coupled to a Graphics Processing Unit (GPU), a Digital Signal Processor (DSP), or other specialized processing units that assist in performing specific functions such as image processing, machine learning, or data analysis. The processing device 72 may operate in conjunction with other components of the computing system 70, communicating via the local interface 82.

The memory 74 in the computing system 70 may include any combination of volatile and non-volatile memory components, such as Random-Access Memory (RAM), Read-Only Memory (ROM), flash memory, and other forms of computer-readable storage media. The memory 74 is configured to store software programs, applications, and data that are executed or processed by the processing device 72. The memory 74 may also store an Operating System (O/S) and/or operating instructions that manage the overall operation of the computing system 70. In some embodiments, the memory 74 may be further subdivided into different types, such as main memory (e.g., dynamic RAM) for temporary storage of active data, and secondary memory (e.g., non-volatile memory) for storing data persistently even when the system is powered down. The memory 74 may be dynamically allocated by the computing system 70, and it may be accessible by the processing device 72 and other components via the local interface 82.

The I/O devices 76 allow the computing system 70 to interact with a user, the external environment, and other systems. Input devices may include, but are not limited to, keyboards, mice, touchscreens, microphones, and other sensors or control devices that enable the user to input commands or data into the system. Output devices may include displays, printers, speakers, or haptic feedback devices that allow the computing system 70 to convey information or feedback to the user or external systems. In some embodiments, the I/O devices 76 may also include peripheral devices such as cameras, scanners, or biometric sensors. These I/O devices 76 may be directly connected to the computing system 70 or may communicate with the computing system 70 wirelessly, such as via the network interface 78.

The network interface 78 facilitates communication between the computing system 70 and external networks, such as network 86, a local area network (LAN), a wide area network (WAN), or the Internet. The network interface 78 may include both wired and wireless communication capabilities, such as Ethernet, Wi-Fi, Bluetooth, or other protocols. The network interface 78 enables the computing system 70 to transmit and receive data, connect to remote servers, or access cloud-based services. In some embodiments, the network interface 78 may be integrated with other components of the computing system 70 or implemented as a separate hardware module, and it may support various network protocols, including Transmission Control Protocol/Internet Protocol (TCP/IP), User Datagram Protocol (UDP), and others. The network interface 78 may also provide security features such as encryption, firewalls, and authentication mechanisms to ensure secure communication.

The data storage device 80 is configured to store data persistently, which may include structured data, unstructured data, program files, system logs, and other forms of digital information. The data storage device 80 may take various forms, such as a Hard Disk Drive (HDD), Solid-State Drive (SSD), or other non-volatile memory technologies. In some embodiments, the data storage device 80 is organized as a database, storing records, tables, and indexes that facilitate the efficient retrieval, updating, and management of data. The data storage device 80 may include multiple components and may be local to the computing system 70 and/or connected via a network to external storage resources, such as cloud-based storage platforms. The processing device 72 may interact with the data storage device 80 to retrieve and store data required for executing software applications, maintaining system logs, or providing data for analytical processes.

The various hardware components of the computing system 70, including the processing device 72, memory 74, I/O devices 76, network interface 78, and data storage device 80, communicate with each other over the local interface 82. This local interface 82 may be implemented as a bus, such as a system bus, memory bus, or input/output bus, which provides a communication pathway between the different components. The bus may be based on any standard bus architecture, including but not limited to Peripheral Component Interconnect (PCI), Universal Serial Bus (USB), or Advanced Microcontroller Bus Architecture (AMBA). In some embodiments, the local interface 82 may include multiple buses or communication channels that handle different types of data traffic, such as high-speed data transfers between the memory 74 and the processing device 72, or lower-speed communication with the I/O devices 76 or peripheral devices. The local interface 82 allows for the efficient exchange of data between components and ensures synchronized operation of the system.

In addition, the computing system 70 includes a ticketing module 84, which may be implemented in any suitable combination of hardware (e.g., in the processing device 72) or software/firmware (e.g., in the memory 74). The ticketing module 84 may be stored in non-transitory computer-readable media (e.g., memory 74) and may include logic code having instructions that, when executed, enable or cause the processing device 72 to perform certain ticket management functions as described in the present disclosure.

### Example Screenshots in a Ticketing System

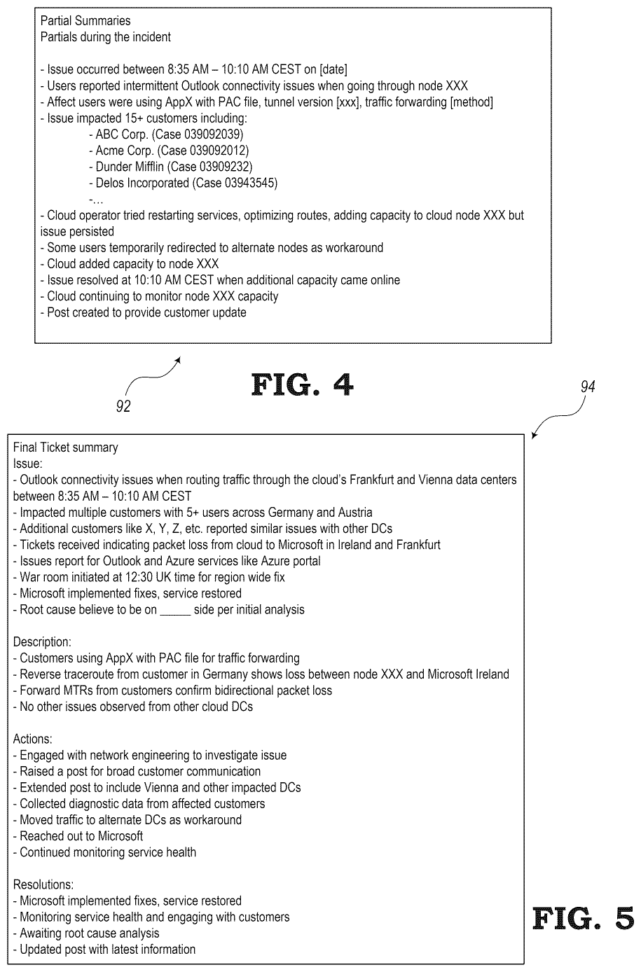

FIG. 4 is an example of a screenshot 92 showing partial summaries of a customer service ticket involving an example situation in which an outage of a software application is detected and managed. As shown in FIG. 4, a number of partial summaries (e.g., short descriptive events, conditions, responses, etc.) are shown. For example, the partial summaries may include a short description of the overall issue to be fixed, the times and dates when the issue was detected, a number of entities (e.g., people, clients, customers, devices, etc.) affected by the issue, a list of the affected entities, root cause analysis, information regarding attempts to resolve the issue, one or more actions that ultimately resolved the issue, on or more actions that partially contributed to resolving the issue, one or more actions that neither resolved the issue nor partially contributed to resolving the issue, domain equipment monitored, time and date when the issue was resolved, etc.

FIG. 5 is an example of a screenshot 94 showing a final ticket summary of the customer service ticket example of FIG. 4. Again, as described with respect to FIGS. 1 and 2, the ticket summary may be considered to be dynamic while a solution is being detected and while additional information or device parameters are being obtained. This may include an iterative process of requesting additional data from a domain user, automatically obtaining additional network metrics, re-processing the updated ticket information with respect to LLM processing and nearest neighbor comparisons with vectors in a vector database, etc.

For example, the final ticket summary shown in FIG. 5 may include a list of a) issues, b) descriptions, c) actions, and d) resolutions. The “issues” in this case may include a brief description of the overall issue, when the issue occurred, where the issue occurred, data centers and domains affected, customer impacted by the issue, reporting information, fixes attempted, root cause analysis, etc. The “description” in this case may include traffic and trace route characteristics obtained. The “actions” in this case may include personnel involvement, raising or extending a trust post, collecting diagnostic data from affected customers, rerouting traffic, contacting software developers or hardware manufacturers, continuing monitoring services, and the like, whereby a “trust post” may refer to an incident resolution status or an issue with an enrollment service. For example, a trust post for the enrollment service might be for issues with new users or re-logins. Also, the “resolutions” in this case may include information regarding fixes, service restorations, service health monitoring, engaging with customers, awaiting third party root cause analysis, updating a trust post, etc.

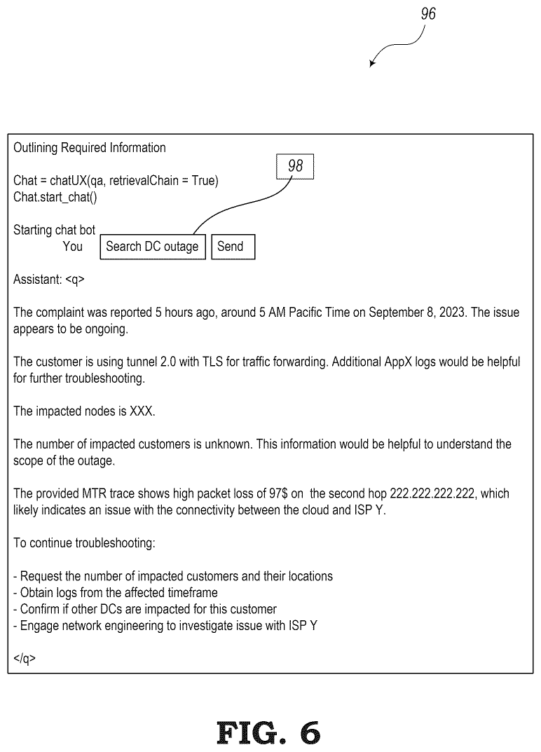

FIG. 6 is an example of a screenshot 96 showing an entry field 98 and a summary in a chatbot. In this example, the user may be able to copy and paste a long entry of a summary and description (with respect to a ticket) in the entry field 98. The LLM or chatbot may be configured to handle the ticket information using the processes described herein to provide summaries and additional instructions as needed to resolve a domain-based issue.

### Ticket Handling Method

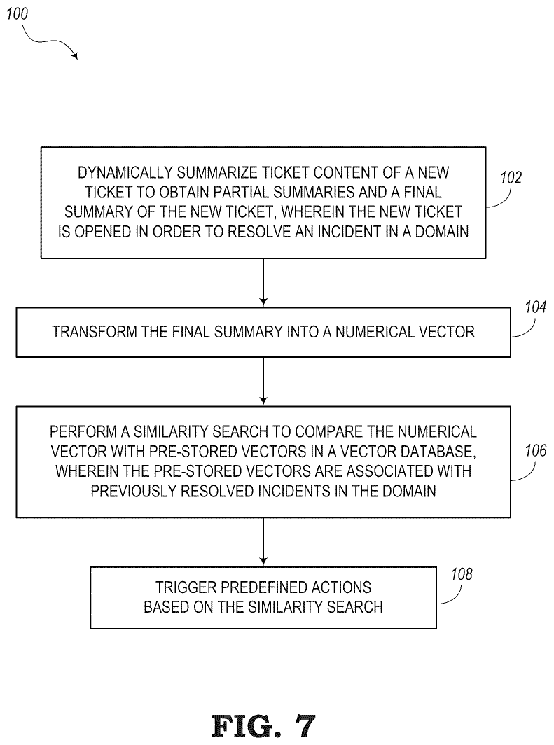

FIG. 7 is a flow diagram illustrating an embodiment of a method 100 for utilizing LLMs for processing a customer service ticket. As shown, the method 100 includes a step of dynamically summarizing ticket content of a new ticket to obtain partial summaries and a final summary of the new ticket, as indicated in block 102. For instance, the new ticket is opened in order to resolve an incident in a domain. The method 100 further includes a step of transforming the final summary into a numerical vector, as indicated in block 104. Also, the method 100 includes a step of performing a similarity search to compare the numerical vector with pre-stored vectors in a vector database, as indicated in block 106. The pre-stored vectors, for example, are associated with previously resolved incidents in the domain. The method 100 also includes a step of triggering predefined actions based on the similarity search, as indicated in block 108.

According to some embodiments, the method 100 may further include a step of employing an LLM trained with previous cloud security tickets and cloud security knowledge. The new ticket, for example, may be related to cybersecurity alerts, issues, and monitored network data within a cloud-based cybersecurity environment. The method 100 may further include steps of a) retrieving ticket descriptions, comments, and updates, and b) cleaning and normalizing ticket data and removing sensitive information for privacy compliance.

In some embodiments, the method 100 may also include utilizing a RAG module to assist with retrieving similar tickets from the vector database. The ticket content, in some embodiments, may include user queries, user questions, initial input, requests, issues, alerts, concerns, new ticket information, descriptions, and/or comments regarding one or more issued detected within a domain. The predefined actions, in some embodiments, may include one or more resolution procedures for resolving or attempting to resolve an incident detected within a domain.

In addition, the method 100 may also include requesting additional data with respect to the domain for updating the partial summaries. The step of triggering predefined actions may include a step of recommending solutions based on the previously resolved incidents. The new ticket, for example, may be related to customer service, customer support, IT support, HR support, project management, workflow management, task management, workflow coordination, application assistance, software development, software bug and issue tracking, solution recommendation, and/or issue resolution.

### Additional Considerations

It may be noted that the systems and methods described herein may provide certain advantages over conventional systems. For example, the embodiments disclosed herein may increase efficiency and may reduce the time needed to resolve each ticket by providing immediate access to relevant historical information. The embodiments may also provide consistency in the system, whereby the present ticketing systems are configured to standardize the handling of similar issues, reducing reliance on individual agents. Also, the present embodiments are able to retain knowledge of prior solutions in an ongoing continuous manner, such as by capturing organizational knowledge from historical cases, facilitating long-term knowledge management, etc. Another advantage is that the present systems are configured to enhance the customer experience by providing accelerated resolution times, promoting proactive responses, and building customer trust.

Thus, benefits of the embodiments of the present disclosure may include:
A. Increased Efficiency:
   1. Reduces time spent on each ticket.
   2. Provides immediate access to relevant information.
B. Consistency:
   1. Ensures uniform handling of similar issues.
   2. Reduces reliance on individual agent experience.
C. Knowledge Retention:
   1. Leverages historical data effectively.
   2. Captures organizational knowledge for future use.
D. Improved Customer Satisfaction:
   1. Faster resolutions enhance the customer experience.
   2. Proactive responses build customer trust.

The systems and methods are configured to handle any number of customer domains, based on pre-stored historical resolution plans and knowledge of each domain or customer. The feature of being domain specific may include training with supervisory or historical ticket data and relying on a knowledge base defining each specific type of domain. The knowledge base may include domain-specific terminology, knowledge, keywords, common issues, etc. with respect to each type of domain. Private data regarding cloud-based security environments may include an understanding of cloud security terminology and services, including precise context-aware automation to improve efficiency. For example, the domain may be a cybersecurity system, domain, environment, platform, etc.

The data ingestion layer may be configured to receive ticket data, comments, and updates. The pre-processing engine may include APIs between user input and ticketing engine (or customer support system) with the LLM. The pre-processing engine may be configured to clean and normalize data and remove sensitive data to comply with privacy regulations. The embedding module and vector database may convert ticket data from multiple historical tickets with solutions to numerical vectors and store these vectors in the vector database and enable searching with new vector of new ticket data for similarity with stored vectors to get recommended solutions. The action triggering module may be based on NLP of pre-determined ticket data and patterns thereof, as compared in the similarity search, and can get solutions from the similar tickets fetched from the vector DB and automatically perform or recommend a suitable solution.

The summarization units may be configured dynamically creating and modifying partial summaries and final summaries. Also, the systems and methods may be configured to combine tickets related to the same or similar issues to reduce ticket fatigue. Issues or incidents to be resolved may include network congestion, data center routing, service downtime, authentication problem, access failure, problems with security configuration and policy settings. Advantages of the present embodiments may further include reducing time on each ticket, providing immediate feedback to relevant information, ensuring uniform handling of similar issues, reducing reliance on human bias, and ongoing training to improve results.

In some embodiments, the LLM may be configured to automatically generate a summary of each support ticket upon ticket creation and continuously update the summary with new ticket information. The embedding model, for example, may be configured to process ticket content into vector representations for semantic comparison with historical ticket data, enabling solution recommendations based on similarity searches. The action triggering module, for example, may be configured to detect predefined keywords or patterns in ticket comments and initiate automated actions, including requesting additional diagnostics, suggesting relevant support tools, or escalating the ticket.

A process for enhancing customer support in a cloud-based security platform may include steps of a) retrieving ticket data, including descriptions, comments, and updates, from a ticketing system, b) processing and cleaning the retrieved data to remove sensitive information, c) generating an initial summary of each ticket upon ticket creation and updating the summary as new information is added, d) transforming ticket content into vector representations and conducting similarity searches within a historical database to recommend solutions, and e) analyzing ticket comments for specific keywords or patterns and triggering automated support actions based on detected patterns.

Furthermore, in some embodiments, the process may also be characterized in that the similarity search is configured to identify and recommend historical solutions based on embedding-based semantic analysis of ticket content. The automated support actions may include triggering requests for additional information, tool recommendations, or ticket escalation in response to predefined triggers in ticket comments.

Customer support teams, such as those for cloud-based security companies, may be configured to handle numerous tickets daily, many involving recurring issues such as:
1) Network Congestion: Problems with data center paths affecting performance.
2) VIP Downtime: Downtime impacting service availability.
3) Authentication Challenges: User authentication failures or access denials.
4) Policy Misconfigurations: Errors from incorrect security policy settings.
   Currently, resolving these issues may include a) multiple interactions with customers to gather information, b) manual searches through past tickets, and c) dependence on individual agent experience. However, since this manual process is time-consuming and can delay issue resolution, the systems and methods of the present disclosure are configured to overcome the shortcomings of the conventional systems and provide efficient and fast ticketing processes.

The embodiments of the present disclosure are configured to revolutionize customer support workflows within certain environments, such as a cloud-based security platform, by leveraging LLMs. The embodiments enhance customer support by integrating LLMs and embedding techniques. The systems and methods of the present disclosure are configured to

### A. Automatically and Dynamically Summarizing Ticket Progress

1. Automatic Generation: Creates concise summaries upon ticket creation.
2. Real-Time Updates: Continuously updates summaries as new information arrives.
3. Key Details Included: Issue descriptions, actions taken, findings, and next steps.

These may include a) Initial Summary—Generated upon ticket creation, b) Updates—Summaries are refreshed as new data is added, and c) Access—Agents view summaries for a quick ticket overview.

### B. Recommending Solutions Based on Historical Data

1. Semantic Analysis: Uses embedding models to represent ticket content.
2. Similarity Search: Compares current tickets to past ones stored in a vector database.
3. Recommendation Generation: Suggests proven solutions from similar historical cases.

These may include a) Vector Representation—Processes ticket content into embeddings, b) Similarity Search—Finds similar past tickets, and c) Recommendation—Suggests solutions based on historical resolutions.

### C. Automatically Triggering Actions Based on Ticket Content and Comment Analysis

1. Real-Time Monitoring: Analyzes ticket comments for specific keywords or patterns.
2. Predefined Actions: Automatically triggers actions like requesting diagnostics, suggesting tools (e.g., ZDX), or escalating tickets.
3. Proactive Response: Ensures timely and appropriate actions are taken without manual intervention.

These may include a) Monitoring—Watches for specific phrases or patterns, and b) Actions—Triggers requests for more information, tool suggestions, or escalations.

By addressing these three areas, the systems and methods of the present disclosure are configured to enhance efficiency, reduce resolution times, and improve overall customer satisfaction. The present systems may be specifically tailored to understand cloud security terminology (and Zscaler's services), providing precise, context-aware automation that significantly improves support efficiency.

In some embodiments, a ticketing system may include an automated system for dynamic summarization of customer support tickets, utilizing a domain-specific Large Language Model to generate and update summaries in real-time. A method may include recommending solutions to support tickets by semantically comparing current ticket content to historical tickets using embedding models and vector databases. Also, a system may include automated action triggering based on real-time comment analysis, detecting specific patterns or keywords and performing predefined actions accordingly.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUS); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

1. A ticketing system for automating customer support, the ticketing system comprising:
a processing device and memory storing instructions that, when executed by the processing device, cause the processing device to implement the following modules.
a domain-specific Large Language Model (LLM) trained on historical customer support data;
an embedding module configured to transform ticket content into numerical vectors stored in a vector database; and
an action triggering module that analyzes data of a new ticket to detect specific patterns and keywords, the action triggering module configured to trigger predefined actions based on a similarity search in the vector database.
wherein the processing device is further configured to:
preprocess the ticket content to normalize input and remove or mask personally identifiable or sensitive information in compliance with privacy requirements:
update the vector database with the ticket vectors and corresponding resolution outcomes; and
automatically trigger execution of remediation actions within a ticket-management workflow without manual agent selection.

2. The ticketing system of claim 1, further comprising a summarization module configured to dynamically summarize ticket content of a new ticket into partial summaries and a final summary, wherein the summarization is performed in real time as additional ticket data is received.

3. The ticketing system of claim 1, wherein the LLM is trained with respect to previous cloud security tickets and cloud security knowledge, including monitored network data, historical resolution procedures, and domain-specific cybersecurity terminology.

4. The ticketing system of claim 1, further comprising:
a data ingestion layer that interfaces with a ticketing system to retrieve ticket descriptions, comments, and updates; and
a pre-processing engine configured to clean and normalize ticket data and remove sensitive information for privacy compliance, wherein the pre-processing engine applies anonymization, tokenization, and encryption techniques.

5. The ticketing system of claim 1, further comprising a Retrieval-Augmented Generation (RAG) module configured to assist with retrieving similar tickets from the vector database, wherein the RAG module integrates retrieved content into a generated response or recommendation.

6. The ticketing system of claim 1, wherein the ticket content includes user queries, user questions, initial input, requests, issues, alerts, concerns, new ticket information, descriptions, and/or comments regarding one or more issued detected within a domain, and wherein the ticket content is structured into a semantic embedding prior to storage.

7. The ticketing system of claim 1, wherein the predefined actions include one or more resolution procedures for resolving or attempting to resolve an incident detected within a domain, the resolution procedures comprising at least one of automated configuration changes, network rerouting, or initiating diagnostic tools.

8. A computing system comprising:
a processing device; and
a memory device configured to store a computer program having instructions that, when executed, enable the processing device to
dynamically summarize ticket content of a new ticket to obtain partial summaries and a final summary of the new ticket, wherein the new ticket is opened in order to resolve an incident in a domain,
transform the final summary into a numerical vector,
perform a similarity search to compare the numerical vector with pre-stored vectors in a vector database, wherein the pre-stored vectors are associated with previously resolved incidents in the domain, and
trigger predefined actions based on the similarity search,
wherein the processing device is further configured to preprocess the ticket content for privacy compliance, employ a Retrieval-Augmented Generation (RAG) step, and automatically log outcomes of triggered actions for continuous training of a Large Language Model (LLM) trained with previous cloud security tickets and cloud security knowledge.

9. The computing system of claim 8, wherein the instructions further enable the processing device to dynamically summarize ticket content of the new ticket into partial summaries and a final summary, transform the final summary into a numerical vector, compare the numerical vector with vectors stored in the vector database that are associated with previously resolved incidents, and trigger remediation actions within the ticket-management workflow based on results of the comparison.

10. The computing system of claim 9, wherein the new ticket is related to cybersecurity alerts, issues, and monitored network data within a cloud-based cybersecurity environment, and wherein similarity search results are contextualized using cybersecurity-specific embeddings.

11. The computing system of claim 8, wherein the instructions further enable the processing device to:
retrieve ticket descriptions, comments, and updates; and
clean and normalize ticket data and remove sensitive information for privacy compliance, including applying anonymization rules in accordance with data protection regulations.

12. The computing system of claim 8, wherein the instructions further enable the processing device to utilize a Retrieval-Augmented Generation (RAG) module to assist with retrieving similar tickets from the vector database, and to generate enriched ticket summaries using retrieved contextual information.

13. The computing system of claim 8, wherein the ticket content includes user queries, user questions, initial input, requests, issues, alerts, concerns, new ticket information, descriptions, and/or comments regarding one or more issued detected within a domain.

14. The computing system of claim 8, wherein the predefined actions include one or more resolution procedures for resolving or attempting to resolve an incident detected within a domain, the resolution procedures comprising automated deployment of patches, reconfiguration of security policies. or escalation to a human support agent.

15. The computing system of claim 8, wherein the instructions further enable the processing device to request additional data with respect to the domain for updating the partial summaries, the additional data being obtained via telemetry, monitoring systems, or customer input.

16. The computing system of claim 8, wherein triggering predefined actions includes recommending solutions based on the previously resolved incidents, and automatically ranking the solutions by historical effectiveness.

17. The computing system of claim 8, wherein the new ticket is related to customer service, customer support, IT support, HR support, project management, workflow management, task management, workflow coordination, application assistance, software development, software bug and issue tracking, solution recommendation, and/or issue resolution.

18. A method comprising steps of:
dynamically summarizing ticket content of a new ticket to obtain partial summaries and a final summary of the new ticket, wherein the new ticket is opened in order to resolve an incident in a domain;
transforming the final summary into a numerical vector;
performing a similarity search to compare the numerical vector with pre-stored vectors in a vector database, wherein the pre-stored vectors are associated with previously resolved incidents in the domain,
triggering predefined actions based on the similarity search,
preprocessing the new ticket to remove or mask personally-identifiable or sensitive information,
employing a Retrieval Augmented Generation (RAG) step to augment responses with retrieved historical tickets, and
automatically initiating remediation actions in a customer domain workflow.

19. The method of claim 18, further comprising a step of employing a Large Language Model (LLM) trained with previous cloud security tickets and cloud security knowledge, wherein the new ticket is related to cybersecurity alerts, issues, and monitored network data within a cloud-based cybersecurity environment.

20. The method of claim 18, further comprising steps of:
retrieving ticket descriptions, comments, and updates; and
cleaning and normalizing ticket data and removing sensitive information for privacy compliance, including anonymization and encryption of personally identifiable information.
